(19) United States
(12) Patent Application Publication
(10) Pub. No.: US 2007/0270103 A1
(43) Pub. Date: Nov. 22, 2007

(54) Method and apparatus for transmitting/receiving uncompressed audio/video data

(75) Inventor: Ki-bo Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/714,122

(22) Filed: Mar. 6, 2007

Related U.S. Application Data
(60) Provisional application No. 60/800,429, filed on May 16, 2006.
(60) Provisional application No. 60/811,797, filed on Jun. 8, 2006.

(30) Foreign Application Priority Data
Sep. 4, 2006 (KR) 10-2006-0084876

(51) Int. Cl. H04B 7/00

(52) U.S. Cl. 455/69

(57) ABSTRACT

A method and apparatus of transmitting uncompressed audio and/or video (AV) data are provided. The method includes transmitting the uncompressed AV data; determining whether an error occurs in the uncompressed AV data during the transmission; and if it is determined that the error occurs in the uncompressed AV data, retransmitting a portion of the uncompressed AV data having a predetermined level of significance.

### CROSS REFERENCE TO RELATED APPLICATIONS

This application is based on, and claims priority from Korean Patent Application No. 10-2006-0084876 filed on Sep. 4, 2006, in the Korean Intellectual Property Office, and U.S. Provisional Patent Application Nos. 60/800,429 filed on May 16, 2006 and 60/811,797 filed on Jun. 8, 2006 in the United States Patent and Trademark Office, the disclosures of which are entirely incorporated herein by reference.

### BACKGROUND OF THE INVENTION

1. Field of the Invention

Methods and apparatuses consistent with the present invention relate to a wireless communication technique, and more particularly, to changing a code rate to effectively retransmit uncompressed audio/video data.

2. Description of the Related Art

With advancements made to wireless network techniques, the demand for transmitting mass multimedia data has been increasing, along with the demand for an effective transmission method in a wireless network environment. In addition, the necessity for wireless transmission of a high-quality video, such as a digital video disk (DVD) video, a high definition television (HDTV) video, among various home devices is also increasing.

Currently, a task group of Institute of Electrical and Electronics Engineers (IEEE) 802.15.3c is considering a technical standard for transmitting mass data over a wireless home network. This standard, called a millimeter wave (mmWave), uses an electric wave having a physical wavelength of several millimeters to transmit mass data (that is, an electric wave having a frequency of 30 GHz to 300 GHz). In the related art, this frequency band is an unlicensed band and is limitedly used for, for example, communication carriers, radio astronomy, or vehicle anti-collision.

FIG. 1 is a diagram illustrating a comparison between the frequency band of the IEEE 802.11 standards and the frequency band of the mmWave. In the IEEE 802.11b standard or the IEEE 802.11g standard, a carrier frequency is 2.4 GHz, and a channel bandwidth is about 20 MHz. Further, in the IEEE 802.11a standard or the IEEE 802.11 n standard, a carrier frequency is 5 GHz, and a channel bandwidth is about 20 MHz. In contrast, in the mmWave, a carrier frequency of 60 GHz is used, and a channel bandwidth is in the range of about 0.5 to 2.5 GHz. Accordingly, it can be seen that the mmWave has a considerably higher carrier frequency and a considerably larger channel bandwidth than the existing IEEE 802.11 standards. As such, if a high-frequency signal having a wavelength in millimeters (millimeter wave) is used, a high transmission rate of several Gbps can be obtained, and the size of an antenna can be set to be smaller than 1.5 mm. Therefore, a single chip including the antenna can be implemented. In addition, since an attenuation ratio is very high in the air, the interference between apparatuses can be reduced.

In recent years, a technique for transmitting uncompressed audio and/or video (AV) data between wireless apparatuses using the mmWave having a large bandwidth has been studied. Compressed AV data is compressed with a partial loss through processes, such as motion compensation, discrete cosine transform (DCT) conversion, quantization, and variable length coding, such that portions of the data insensitive to the sense of sight or the sense of hearing of human beings are eliminated. In contrast, uncompressed AV data includes digital values (for example, R, G, and B components) representing pixel components.

Therefore, there is no significant difference between bits included in the compressed AV data, but there is a notable difference between bits included in the uncompressed AV data. For example, as shown in FIG. 2, in case of an 8-bit image, one pixel component is represented by 8 bits. Among the 8 bits, a bit representing the highest order (a bit at the highest level) is the most significant bit (MSB), and a bit representing the lowest order (a bit at the lowest level) is the least significant bit (LSB). That is, in 1-byte data composed of 8 bits, the bits have different significances in restoring a video signal or an audio signal. When an error occurs in a bit having high significance during transmission, it is possible to detect the error easier than when the error occurs in a bit having low significance. Therefore, it is necessary to protect bit data having high significance such that no error occurs in the bit data during wireless transmission, as compared to bit data having low significance. However, a related art transmission method of correcting errors of all bits to be transmitted at the same code rate has been used in the IEEE 802.11 standards.

FIG. 3 is a diagram illustrating the structure of a physical layer protocol data unit (PPDU) of the IEEE 802.11a standard. PPDU 30 includes a preamble, a signal field, and a data field. The preamble is a signal used for synchronizing a physical layer (PHY layer) and estimating a channel, and includes a plurality of short training signals and a plurality of long training signals. The signal field includes a RATE field indicating a transmission rate and a LENGTH field indicating the length of the PPDU. In general, the signal field is encoded by one symbol. The data field is composed of PSDU, a tail bit, and a pad bit, and data to be transmitted actually is included in PSDU.

Data recorded on PSDU is composed of codes encoded by a convolution encoder. There is no difference in significance between the codes, but the codes have been encoded by the same error correction coding process. Therefore, the codes have the same error correcting capability. When a receiver detects an error and then requests a transmitter to retransmit data (through acknowledgment (ACK)), the transmitter retransmits all corresponding data.

The related art method is effective in transmitting general data. However, when there is a notable difference between data to be transmitted, a better error correction coding process should be performed on bits having higher significance to reduce the probability that an error occurs in the bits.

The transmitter performs an error correction coding process on data in order to prevent occurrence of an error. Even when an error occurs in the coded data, the coded data having the error can be restored in a predetermined range in which the error can be corrected. There are various error correction coding processes, and the error correction coding processes have different capabilities to correct errors according to error correction coding algorithms. The performance of the error correction coding algorithms depends on a code rate.

In general, as the code rate becomes higher, the transmission efficiency of data becomes higher, but the capability to correct errors is lowered. In contrast, as the code rate becomes lower, the transmission efficiency of data becomes lower, but the capability to correct errors is raised. However, as described above, in the uncompressed AV data, there is difference in significance between bits constituting an uncompressed AV data, unlike the compressed AV data. Therefore, it is necessary to protect high-level bits having high significance such that no error occurs in the high-level bits during transmission.

In general, the following methods are used to stably transmit wireless data: a method of using error correction coding to restore data; and a method of retransmitting data having an error from a transmitter to a receiver. By contrast, the present invention provides a method of selectively retransmitting important data having a great effect on the quality of uncompressed AV data to be restored when an error occurs in the uncompressed AV data during transmission.

### SUMMARY OF THE INVENTION

The present invention provides a method and apparatus for effectively retransmitting uncompressed AV data to ensure stable transmission of the uncompressed AV data.

The present invention also provides a detailed packet structure of retransmitted data.

The present invention is not limited to those mentioned above, and other aspects of the present invention will be apparently understood by those skilled in the art through the following description.

According to an aspect of the present invention, there is provided a method of transmitting uncompressed AV data, the method including transmitting the uncompressed AV data; determining whether an error occurs in the uncompressed AV data during the transmission; and if it is determined that the error occurs in the uncompressed AV data, retransmitting a portion of the uncompressed AV data having a predetermined level of significance.

According to another aspect of the present invention, there is provided a method of receiving uncompressed AV data, the method including receiving the uncompressed AV data; determining whether an error occurs in the received uncompressed AV data; and if it is determined that the error occurs in the received uncompressed AV data, requesting a transmitting apparatus which transmitted the uncompressed AV data to retransmit a portion of the uncompressed AV data having a predetermined level of significance.

According to still another aspect of the present invention, there is provided an apparatus for transmitting uncompressed AV data, the apparatus including a bit separating unit which separates the uncompressed AV data into a plurality of levels; a channel coding unit which performs, when an error occurs in the uncompressed AV data during transmission, error correction coding on a portion of the uncompressed AV data having a predetermined level of significance; and a radio frequency (RF) unit which retransmits the coded bits.

According to yet another aspect of the present invention, there is provided an apparatus for receiving uncompressed AV data, the apparatus including an RF unit which receives the uncompressed AV data; a channel decoding unit which performs error correction decoding on the uncompressed AV data and determines whether an error occurs in the received uncompressed AV data; and an error response generating unit which requests a transmitting apparatus having transmitted the uncompressed AV data to retransmit a portion of the uncompressed AV data having a predetermined level of significance if it is determined that the error occurs in data included in the portion of the uncompressed AV data.

### BRIEF DESCRIPTION OF THE DRAWINGS

The above and other aspects of the present invention will become more apparent by describing in detail preferred embodiments thereof with reference to the attached drawings, in which:

FIG. 1 is a diagram illustrating the comparison between the frequency band of the IEEE 802.11 standard and the frequency band of a millimeter wave;

FIG. 2 is a diagram illustrating one pixel component having a plurality of bit levels;

FIG. 3 is a diagram illustrating the structure of PPDU of the IEEE 802.11a standard;

FIG. 4 is a diagram illustrating a method of retransmitting data according to a related art;

FIG. 5 is a diagram illustrating a method of retransmitting data according to an exemplary embodiment of the invention;

FIG. 6 is a block diagram illustrating the structure of a transmitting apparatus for transmitting uncompressed AV data according to an exemplary embodiment of the invention;

FIG. 7 is a diagram illustrating a process of multiplexing separated bits of sub-pixels;

FIG. 8 is a diagram illustrating a set of bits multiplexed by scanning shown in FIG. 7;

FIG. 9A is a diagram illustrating the structure of a transmission packet according to an exemplary embodiment of the invention;

FIG. 9B is a diagram illustrating the structure of a PHY header according to an exemplary embodiment of the invention;

FIG. 9C is a diagram illustrating an HRP mode index table according to an exemplary embodiment of the invention;

FIG. 10 is a diagram illustrating the structure of a transmission packet according to another exemplary embodiment of the invention;

FIG. 11 is a diagram illustrating the structure of a receiving apparatus for receiving uncompressed AV data according to an exemplary embodiment of the invention;

FIG. 12 is a flow chart illustrating a method of transmitting uncompressed AV data according to an exemplary embodiment of the invention; and

FIG. 13 is a flow chart illustrating a method of receiving uncompressed AV data according to an exemplary embodiment of the invention.

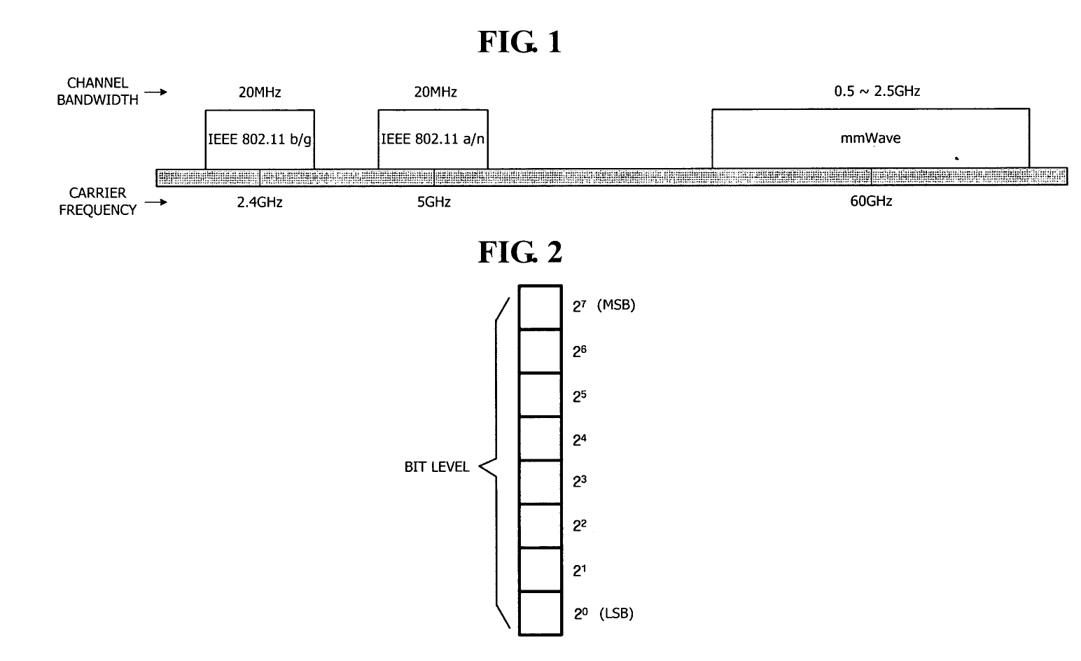

### DESCRIPTION OF EXEMPLARY EMBODIMENTS

Aspects of the present invention may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinafter, the exemplary embodiments of the present invention will now be described more fully with reference to the accompanying drawings.

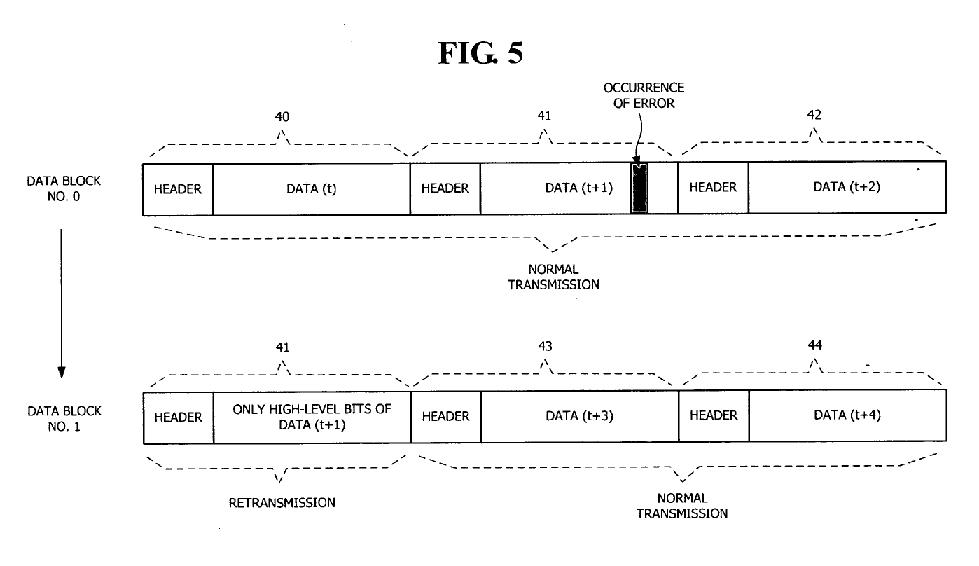

FIG. 4 is a diagram illustrating a data retransmitting method according to a related art. Each transmission packet includes a header and a data area. The header includes additive information on the transmission packet, and a payload to be transmitted actually is included in the data area. In FIG. 4, characters in parentheses next to data indicate the order in which data is transmitted. For example, after data (t) is transmitted, data (t+1) is transmitted.

In FIG. 4, data block No. 0 includes three transmission packets 40, 41, and 42. If no error occurs in the three transmission packets 40, 41, and 42 at the time of transmission, the next transmission packets will be sequentially transmitted in the next data block No. 1. However, if a transmission error occurs in the transmission packet 41 included in the data block No. 0, the transmission packet 41 having the error and the next transmission packets 43 and 44 are transmitted in the data block No. 1. In this case, the data (t+1) included in the transmission packet 41 is retransmitted, and the same error correction encoding method as that used when the data is transmitted at the beginning is applied to the data (t+1).

When a channel is in a good condition, the retransmission enables data to be received without errors. However, when the channel is in a bad condition, there is little probability that data will be received without error although the retransmission is repeated.

The related art is effective in transmitting general data having little difference in significance between bits constituting the data. That is, since there is no difference in significance between bits of data to be transmitted, it is unnecessary to use different methods for the most significant bit (MSB) and the least significant bit (LSB) of the data for retransmission or coding for error correction. In addition, it is necessary to receive all data without errors. Therefore, when an error occurs, retransmission should be continuously performed until normal data is received, or a code rate should be lowered to use a strong error correction encoding algorithm. Since general data (asynchronous data) does not need to be transmitted or received in real time, a low transmission rate does not matter.

However, when data to be transmitted is AV data, the data should be transmitted in real time. When the transmission rate of the AV data is lower than a predetermined value, an image stops being played, or is slowly played. Therefore, it is difficult to arbitrarily lower the transmission rate of the AV data. However, uncompressed AV data has different effects on audio and video signals according to the positions of bits of data, unlike compressed AV data. That is, in one byte data, a high-level bit has a greater effect on the quality of video or audio than a low-level bit. Therefore, when an error occurs in the high-level bit, the degree of distortion having an effect on a video or audio signal is greater than that when an error occurs in the low-level. Thus, the retransmission method shown in FIG. 4 is not suitable for transmitting uncompressed AV data.

According to an exemplary embodiment of the invention, when an error occurs in uncompressed AV data during transmission, only a group of high-level bits having a great effect on the recognition range of human beings among bits of the data having the error is retransmitted. In this case, a code rate for correcting the error of the retransmitted data may be set to the same value as that used when the data is transmitted at the beginning. As a result, the amount of data to be retransmitted is smaller than that when the data is transmitted at the beginning.

According to another exemplary embodiment of the invention, when an error occurs in uncompressed AV data during transmission, only a group of high-level bits is retransmitted, and a code rate for correcting the error may be lower than that when the data is transmitted at the beginning, which makes it possible to improve capability to correct errors.

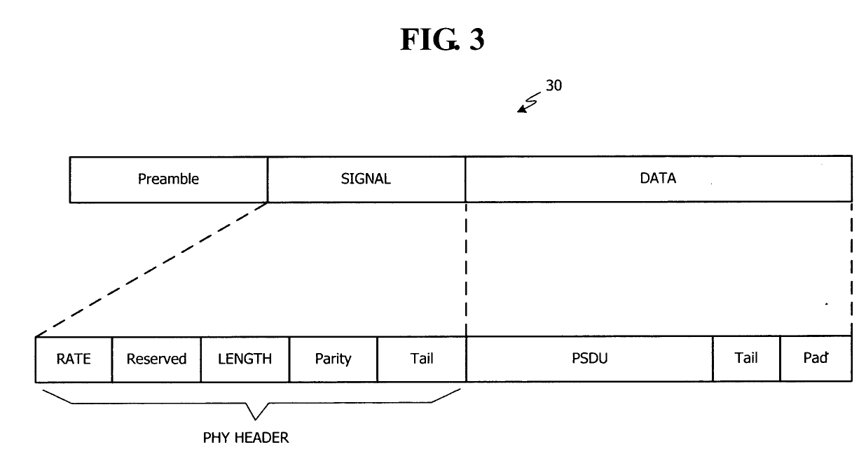

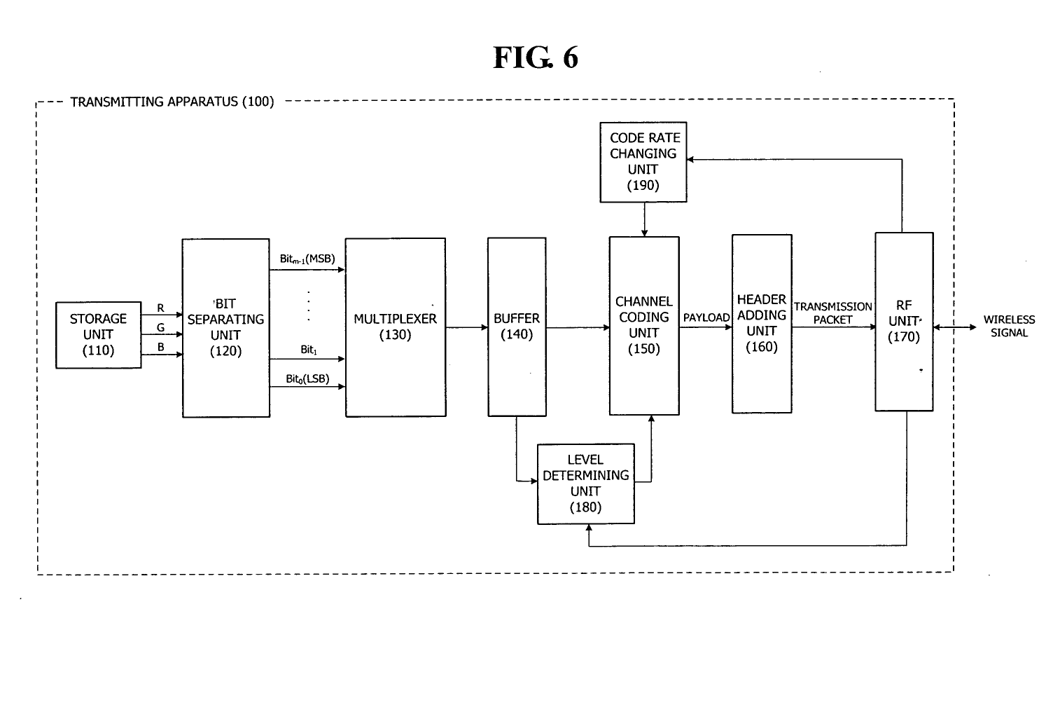

FIG. 5 is a diagram illustrating a retransmission method according to an exemplary embodiment of the invention. When an error occurs in the transmission packet 41 of data block No. 0 during reception, only a group of high-level bits of data (t+1), for example, only the top 4 bits (the top 4 bits in FIG. 2) of AV data represented by 8 bits may be retransmitted. In this case, the amount of data to be transmitted is reduced by half.

In this way, when some bits of the data (t+1) is retransmitted to reduce the amount of data to be retransmitted, it is possible to lower a code rate for error correction coding to half the code rate when the data is transmitted at the beginning while maintaining the same data transmission rate as that when the data is transmitted at the beginning. As a result, it is possible to considerably lower the probability of error occurring.

If only the top 2 bits of AV data represented by 8 bits are retransmitted, the amount of data to be retransmitted is reduced to a quarter of the amount of data when the data is transmitted at the beginning. As a result, the code rate for error correction coding is reduced to a quarter of the code rate when the data is transmitted at the beginning, which makes it possible to considerably lower the probability of error occurring. When uncompressed AV data is retransmitted, information (hereinafter, referred to as “level information”) on the number of bits from the most significant bit to be transmitted among bits of the uncompressed AV data and/or information on a code rate that varies when the data is retransmitted may be shared beforehand between a transmitting apparatus and a receiving apparatus. Alternatively, the transmitting apparatus may record the information on a header of a transmission packet and then transmit the packet to the receiving apparatus.

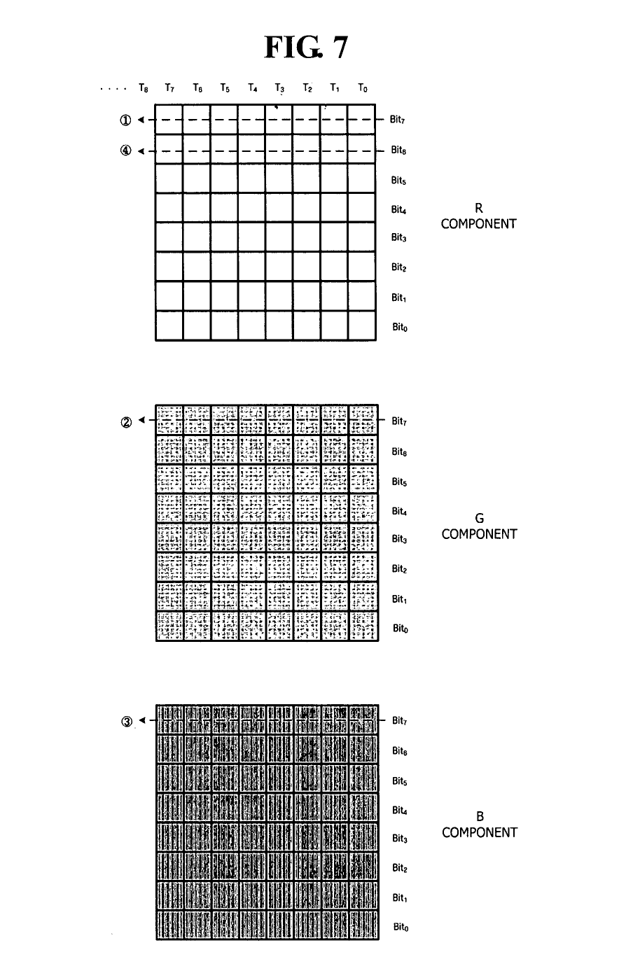

FIG. 6 is a block diagram illustrating the structure of a transmitting apparatus 100 for transmitting uncompressed AV data according to an exemplary embodiment of the invention. The transmitting apparatus 100 includes a storage unit 110, a bit separating unit 120, a multiplexer 130, a buffer 140, a channel coding unit 150, a header adding unit 160, a radio frequency (RF) unit 170, and a level determining unit 180. The transmitting apparatus 100 may further include a code rate changing unit 190.

The storage unit 110 stores uncompressed AV data. When the AV data is video data, sub-pixel values of each pixel are stored in the storage unit 110. The sub-pixel values to be stored in the storage unit 110 may vary according to a color space used (for example, an RGB color space and a YCbCr color space). In this exemplary embodiment of the invention, each pixel includes three sub-pixels, that is, R, G, and B sub-pixels, corresponding to the RGB color space. When the video data is a gray-scale image, only one sub-pixel component exists. Therefore, one pixel may be composed of one sub-pixel, or it may be composed of two or four sub-pixels.

The bit separating unit 120 separates the sub-pixel values (binary values) supplied from the storage unit 110 from a high-order (level) bit to a low-order (level) bit. For example, in case of an 8-bit video signal, the video signal is composed of orders from 20 to 27, and thus it may be separated into 8 bits. In FIG. 6, “m” indicates the number of bits of a pixel, and “Bitₘ₋₁” indicates the bit of an order m−1. The bit separating process is independently performed on each sub-pixel.

After separation of bits according to significance, the multiplexer 125 classifies the separated bits according to their levels and multiplexes the classified bits.

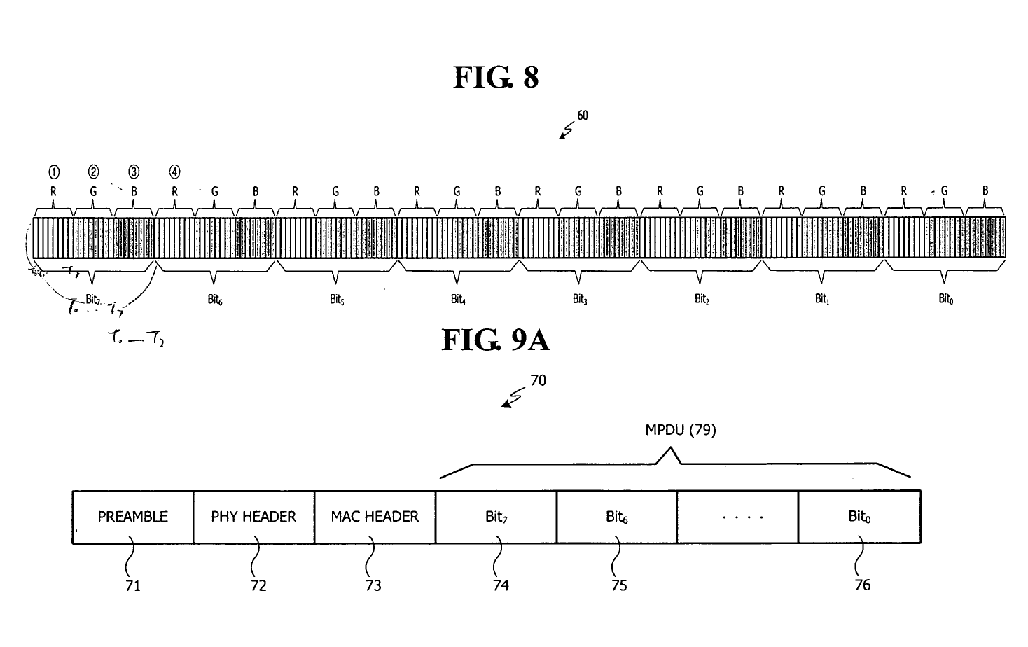

FIG. 7 is a diagram illustrating a process of multiplexing the separated bits of the sub-pixels. In FIG. 7, To T₇ indicate the order of pixels. That is, scanning is sequentially performed on pixels to the left direction from

The sub-pixel values input for the sequential scanning are sequentially stored in a predetermined buffer (not shown). The sub-pixel values may be sequentially stored in a memory in the order in which data is input, and desired bits may be read by scanning in the order of addresses supplied from a data address generator (not shown).

The scanning process is sequentially performed on the bits in the order from the most significant bit to the least significant bit. However, in the scanning process, since one pixel is composed of three components, that is, R, G, and B components, scanning is sequentially performed on the most significant bit of the R component \textcircled{1}, the most significant bit of the G component \textcircled{2}, and the most significant bit of the B component \textcircled{3}. Then, scanning is performed on the next high-level bit Bit₆ of the R component \textcircled{4}. This scanning process is repeated until the least significant bit of the B component is scanned.

In order to reduce a play delay that will occur in the receiver side, the method of alternately scanning bits having the same order (level) of the sub-pixel components is used rather than a method of completely scanning all bits of one sub-pixel component and then scanning the next sub-pixel component. In this exemplary embodiment, scanning is sequentially performed on R, G, and B sub-pixels, but the invention is not limited thereto. For example, the scanning order may vary according to an actual driving mode.

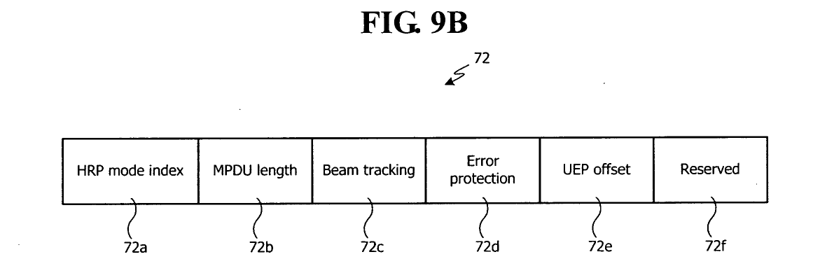

FIG. 8 is a diagram illustrating a set of bits multiplexed by the scanning shown in FIG. 7. In a multiplexed bit stream 60, the bits are arranged in the order from the most significant bit to the least significant bit, and the bits having the same order (level) of the R, G, and B components are alternately arranged.

Referring to FIG. 6, the buffer 140 temporarily stores a bit string multiplexed by the multiplexer 130.

The channel coding unit 150 performs an error correction cording process on the data stored in the buffer 140 at a predetermined code rate to generate a payload. The error correction cording process includes a block cording process and a convolution cording process. In the block coding process (for example, a Reed-Solomon coding process), data is encoded or decoded in the unit of a block. In the convolution coding process, a memory having a predetermined size is used to compare previous data with current data, thereby performing encoding. In general, the block coding process does not cause a burst error, and the convolution coding process does not cause a random error.

Generally, the error correction coding process converts an input k-bit signal into an n-bit codeword. In this case, the code rate is represented by “k/n”. As the code rate becomes lower, the ratio of the bit of the converted codeword to the input bit is larger, which results in an increase in the probability of the error being corrected.

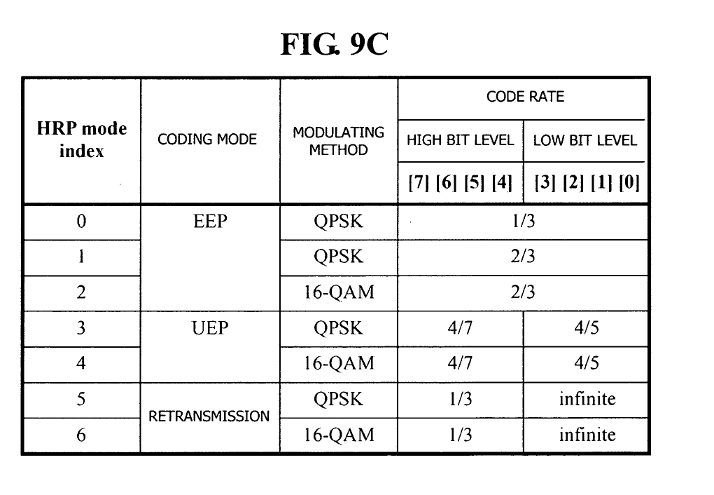

As shown in FIG. 9A, the header adding unit 160 adds a media access control (MAC) header 73, a physical layer (PHY) header 72, and a preamble 71 to a MAC protocol data unit (MPDU) 79 (which is a payload of a MAC level) comprising a plurality of bit groups 74, 75, and 76 to generate a transmission packet 70 according to an exemplary embodiment of the invention. The preamble 71 is a signal for synchronizing a PHY layer (physical layer) and estimating a channel, and is composed of a plurality of short training signals and a plurality of long training signals.

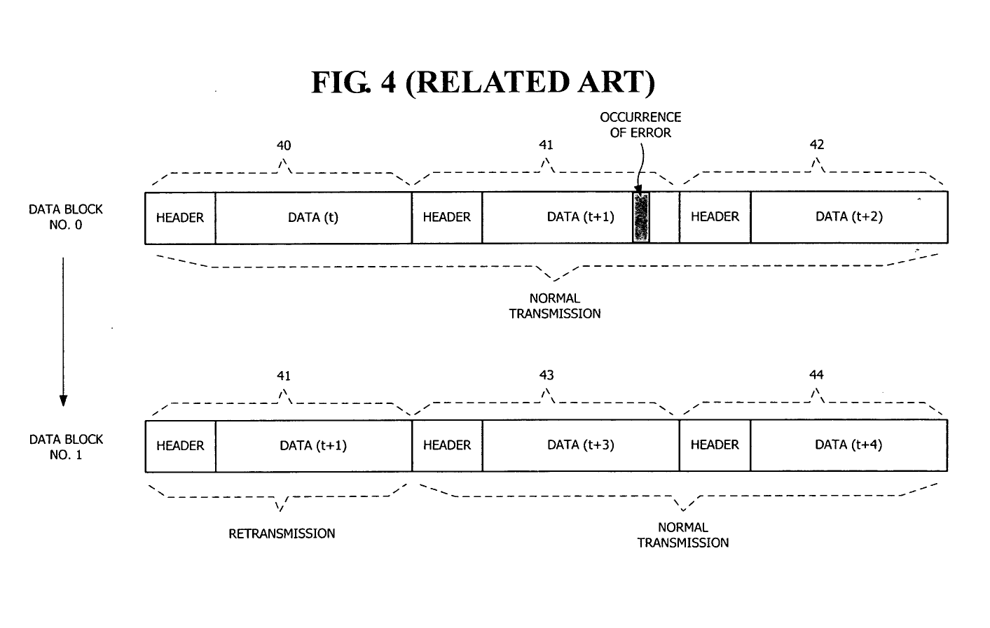

In this exemplary embodiment of the invention, since a transmission rate higher than 3 Gbps is used to transmit uncompressed AV data, the PHY header 72 needs to be different from the PHY header shown in FIG. 3. Therefore, the PHY header 72 is called a high rate PHY (HRP) header.

As shown in FIG. 9B, the PHY header 72 includes an HRP mode index field 72a, an MPDU length field 72b, a beam tracking field 72, an error protection field 72d, an unequal error protection (UEP) offset field 72e, and a reserved field 72f.

The HRP mode index field 72a indicates a code rate and a modulating method used for the MPDU 79. In this exemplary embodiment of the invention, the mode index is defined to have any one of values from 0 to 6, as shown in the table of FIG. 9C.

As can be seen from FIG. 9C, when the HRP mode index is in the range of 0 to 2, equal error protection (EEP) is applied, and when the HRP mode index is 3 or 4, UEP is applied. Only high bit levels Bit₄ to Bit₇ having relatively high significance (which are represented by [7], [6], [5], and [4] in FIG. 9C) are retransmitted at a code rate of ⅓, and low bit levels Bit₀ to Bit₃ having relatively low significance are not transmitted (the code rate is infinite). In this exemplary embodiment of the invention, the eight bit levels are divided into four high bit levels and four low bit levels, but the eight bit levels may be divided at a different ratio. For example, the highest bit level may be defined as a high level bit, or two bit levels from the highest bit level may be defined as high bit levels.

The MPDU length field 72b indicates the size of the MPDU 79 in an octet unit.

The beam tracking field 72C is a 1-bit field. When a transmission packet includes beam tracking information, the beam tracking field 72C is represented by 1. When the transmission packet does not include the beam tracking information, the beam tracking field 72C is represented by 0. Since a millimeter wave (mmWave) supporting a transmission rate of several Gbps has high directionality, a directional array antenna may be used for the transmitting apparatus 100. In this case, beam tracking for finding the optimal directionality of the antenna is required, and the transmitting apparatus 100 needs to transmit information on the beam tracking to the receiving apparatus. The beam tracking field 72c indicates whether the information is included.

The error protection field 72d indicates whether EEP or UEP is applied to bits included in the MPDU 79.

The UEP offset field 72e indicates a symbol number where UEP coding is performed, counting from the first symbol after the MAC header 73.

Meanwhile, the MAC header 73 is used for media access control, as in the IEEE 802.11 standard or the IEEE 802.3 standard, and has, for example, MAC addresses of a transmitter and a receiver, an acknowledgment (ACK) policy, and fragment information recorded thereon.

The RF unit 170 modulates the transmission packet supplied from the header adding unit 160 and transmits the transmission packet through the antenna. For example, the following modulation methods are used: 8VSB, 16VSB, QPSK, 16QAM, 32QAM, 64QAM, 128QAM, and 256QAM.

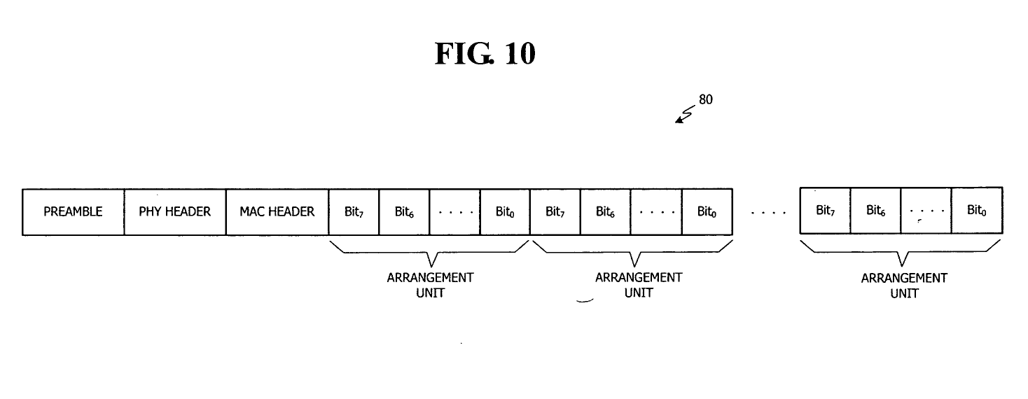

FIG. 10 is a diagram illustrating the structure of a transmission packet 80 according to another exemplary embodiment of the invention. When all bits having the same level form a group, a little delay may occur in the receiver. Therefore, it is considered to classify all bits having the same level into a predetermined number of groups (for example, 8 groups). In this case, scanning is performed on the bits from the most significant bit of the R component to the least significant bit of the B component in a predetermined unit, and then scanning is repeatedly performed on a pixel next the predetermined unit (when the predetermined unit is 8, T₈). Therefore, groups of bits having the same level are repeatedly connected to each other, as shown in FIG. 10. For example, after Bit₀, Bit₇ follows.

When an error occurs in a transmission packet during transmission (for example, the error is detected by receiving ACK from the receiving apparatus), the level determining unit 180 determines what data bit level is included in a transmission packet to be retransmitted. For example, as shown in FIG. 8, assuming that a total of eight bit levels exist, the level determining unit 180 determines that only the top 4 bit levels or only the top 2 bit levels are retransmitted. The smaller the number of bit levels becomes, the smaller the size of the transmission packet to be retransmitted becomes. Therefore, even when a network is in a bad condition, the transmission packet is most likely to be transmitted without errors. When the bit level to be retransmitted is determined in this way, the level determining unit 180 supplies only data having the determined bit level among the data stored in the buffer 140 to the channel coding unit 150. For example, the level determining unit 180 may supply only the bit levels Bit₇ to Bit₄ of the multiplexed bit string shown in FIG. 8 to the channel coding unit 150, or it may supply only the bit levels Bit₇ and Bit₆ to the channel coding unit 150, according to the determined bit level.

In this way, it is possible to reduce only the number of bit levels during retransmission, and to reduce the code rate by the ratio at which the number of bit levels is reduced. When an error occurs in a transmission packet during transmission, the code rate changing unit 190 changes the code rate to a value that is lower than the code rate used when the transmission packet is transmitted, and transmits the changed code rate to the channel coding unit 150. The channel coding unit 150 performs error correction coding on the basis of the changed code rate. In this exemplary embodiment of the invention, it is preferable, but not necessary, that the code rate changing unit 190 reduce the code rate by the reduction ratio of the bit level reduced in the level determining unit 180 at the time of retransmission.

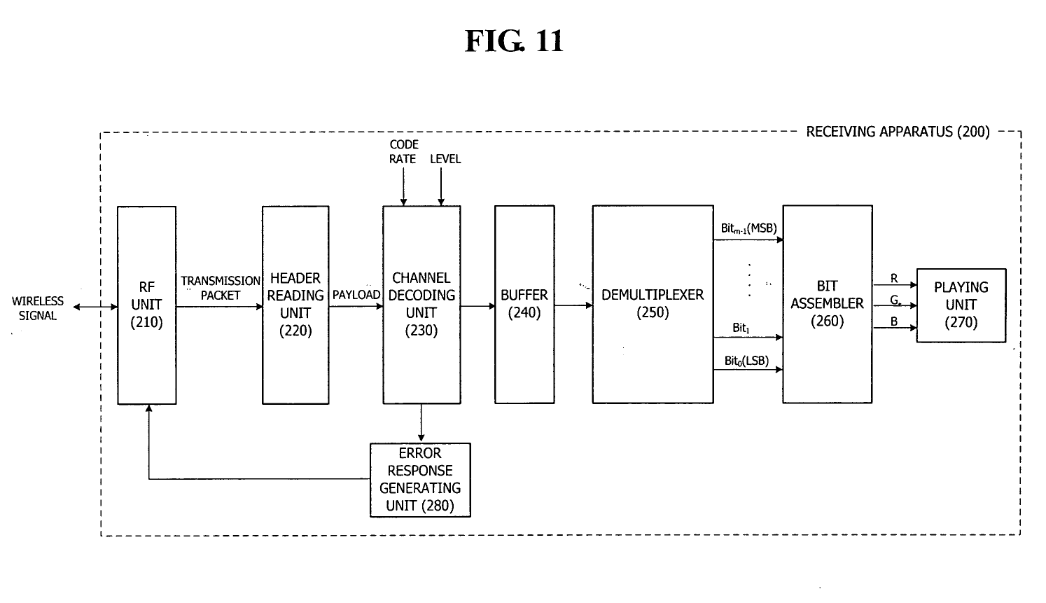

FIG. 11 is a block diagram illustrating the structure of a receiving apparatus 200 for receiving uncompressed AV data according to an exemplary embodiment of the invention. The receiving apparatus 200 includes an RF unit 210, a header reading unit 220, a channel decoding unit 230, a buffer 240, a demultiplexer 250, a bit assembler 260, a playing unit 270, and an error response generating unit 280.

The receiving apparatus 200 requests the transmitting apparatus 100 to retransmit only high-level bits among the bits constituting a transmission packet transmitted from the transmitting apparatus 100 when an error occurs in the transmission packet which is received at the receiving apparatus 200, and combines groups of high-level bits included in the retransmitted transmission packet with groups of low-level bits previously received to generate final reception data. The high-level bits and the low-level bits may be defined beforehand between the transmitting apparatus 100 and the receiving apparatus 200. For example, the top half of all levels may be defined as high levels, and the other half may be defined as low levels.

For example, when an error occurs in a transmission packet, the receiving apparatus 200 temporarily stores groups of low-level bits of the transmission packet in the buffer, and requests the transmitting apparatus to retransmit the groups of high-level bits. Then, the receiving apparatus 200 combines the temporarily stored groups of low-level bits with the retransmitted groups of high-level bits.

However, when an error occurs in the groups of low-level bits of the received transmission packet, the receiving apparatus 200 does not request retransmission. This is because data generated from an LSB group does not have a great effect on the recognition of human being and the retransmission of data makes it possible to reduce the overall data transmission rate.

Referring to FIG. 11, the RF unit 210 demodulates a received wireless signal to restore a transmission packet. The demodulation is reversely performed to the modulation by the RF unit 170 shown in FIG. 6.

The header reading unit 220 reads the PHY header and the MAC header added by the header adding unit 160 shown in FIG. 6 and supplies a payload without the headers to the channel decoding unit 230.

The channel decoding unit 230 performs error correction decoding on a payload encoded at a predetermined code rate (k/n). The error correction decoding is reverse to the error correction coding performed by the channel coding unit 150, and includes a process of decoding the n-bit codeword to the k-bit data, which is the original data. For example, Viterbi decoding is used as a representative example of the error correction decoding.

The channel decoding unit 230 checks whether data restored by the error correction coding has an error. The error check may be performed by calculating the checksum of the restored data. When no error occurs in the restored data or an error occurs in a group of low-level bits, the channel decoding unit 230 does not notify the transmitting apparatus 100 of the occurrence of the error, and stores the restored data in the buffer 240.

When an error occurs in a group of high-level bits, an error response generating unit 280 transmits an error response to the transmitting apparatus 100. The error response may be transmitted by the following methods: when an error occurs, the receiving apparatus 200 notifies the transmitting apparatus 100 of the occurrence of the error; and when no error occurs, the receiving apparatus 200 transmits ACK to the transmitting apparatus 100 and the transmitting apparatus 100 determines that an error occurs when not receiving ACK within a time-out period.

When receiving the error response, the transmitting apparatus 100 retransmits high-level bits of the transmission packet. Then, the channel decoding unit 230 performs error correction decoding on the high-level bits and stores the decoded bits in the buffer 240.

The buffer 240 stores groups of high-level bits retransmitted from the transmitting apparatus and groups of low-level bits previously received, combines the groups to generate final reception data, and transmits the generated data to the demultiplexer 250.

The demultiplexer 250 demultiplexes the received final reception data to separate the data into bits having a plurality of levels. The bits are sequentially separated from the most significant bit Bitₘ₋₁ to the least significant bit Bit₀. When a pixel of video data is composed of a plurality of sub-pixel components, the separated bits may also exist for every sub-pixel component.

A bit assembler 260 assembles the separated bits having a plurality of levels (from the highest level to the lowest level) to restore each sub-pixel component. When some of the low-level bits are not restored, the low-level bits not restored are skipped. The sub-pixel components (for example, R, G, and B components) restored by the bit assembler 260 are supplied to the playing unit 270.

The playing unit 270 collects sub-pixel components, that is, pixel data to form a video frame and displays the video frame on a display device (not shown), such as a cathode ray tube (CRT), a liquid crystal display (LCD), or a plasma display panel (PDP), in synchronization with a play synchronization signal.

In this exemplary embodiment of the invention, uncompressed video data is used as AV data, but the invention is not limited thereto. For example, it will be understood by those skilled in the art that uncompressed audio data, such as a wave file, can be used as the AV data.

The components shown in FIGS. 6 and 11 are realized by software executed in a predetermined area of a memory, such as a task, a class, a sub-routine, a process, an object, an execution thread, or a program, or hardware, such as a field-programmable gate array (FPGA) or an application-specific integrated circuit (ASIC), or they may be realized by combinations of software and hardware. The components may be stored in a computer readable storage medium, or the components may be dispersed in a plurality of computers.

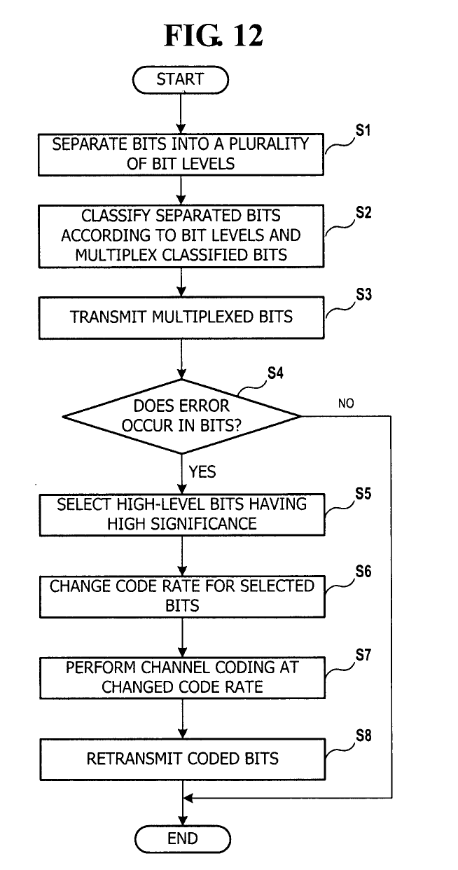

FIG. 12 is a flow chart illustrating a method of transmitting uncompressed AV data according to an exemplary embodiment of the invention.

The bit separating unit 120 separates bits constituting uncompressed AV data into a plurality of levels (S1). Then, the multiplexer 130 classifies the separated bits according to their levels and multiplexes the classified bits, as shown in FIG. 8 (S2). The RF unit 170 transmits the multiplexed bits to the receiving apparatus 200 (S3).

When an error occurs in the uncompressed AV data during transmission (“Yes” in step S4), the channel coding unit 150 selects some bits having high significance (the higher the bit level becomes, the higher the significance becomes) from the bits constituting the uncompressed AV data through the level determining unit 180 (S5), and changes the code rate for the selected bits through the code rate changing unit 190 (S6). The code rate is lowered on the basis of the bit ratio reduced when the data is retransmitted. For example, when the number of bits corresponding to the selected bit level is reduced to half the number of bits when the data is transmitted at the beginning, the code rate is also lowered to half the code rate when the data is transmitted at the beginning. In this way, it is possible to maintain the transmission rate at the same level as that at which the data is transmitted at the beginning while reducing the probability of error occurring when the data is retransmitted.

The channel coding unit 150 performs error correction coding (channel coding) on the selected bits at the changed code rate (S7). Finally, the RF unit 170 retransmits the coded bits to the receiving apparatus 200 (S8).

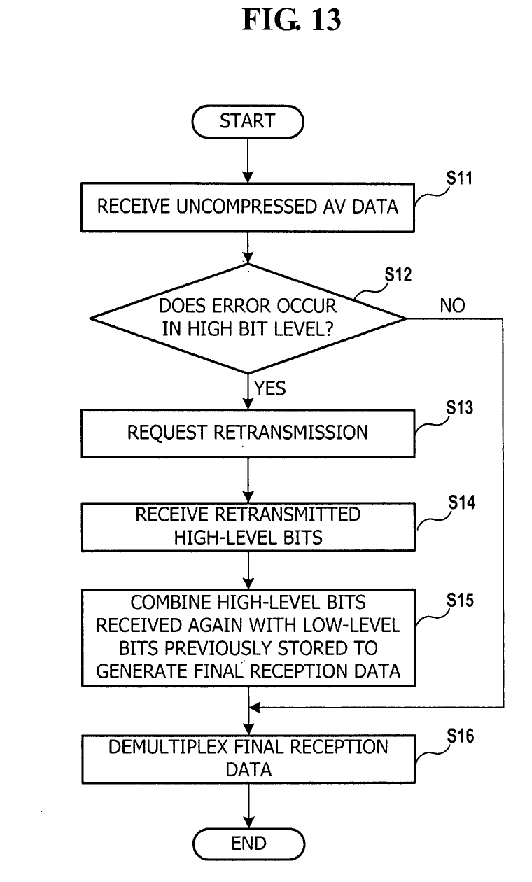

FIG. 13 is a flow chart illustrating a method of receiving uncompressed AV data according to an exemplary embodiment of the invention.

The RF unit 210 receives uncompressed AV data from the transmitting apparatus 100 (S11). The channel decoding unit 230 performs error correction coding on the received uncompressed AV data to check whether an error occurs in high-level bits among bits of the uncompressed AV data (S12).

As the check result, when an error occurs in the high-level bits (“Yes” in S12), the error response generating unit 270 requests the transmitting apparatus to retransmit the uncompressed AV data (S13). Then, the RF unit 210 receives the high-level bits from the transmitting apparatus again (S14), and the demultiplexer 240 combines the received high-level bits with low-level bits of the AV data received at the beginning to generate final reception data (S15). Then, the demultiplexer 240 demultiplexes the generated data to separate the data into a plurality of bit levels (S16).

Although the present invention has been described in connection with the exemplary embodiments of the present invention, it will be apparent to those skilled in the art that various modifications and changes may be made thereto without departing from the scope and spirit of the invention. Therefore, it should be understood that the above exemplary embodiments are not limitative, but illustrative in all aspects.

According to the above-described exemplary embodiments of the invention, it is possible to selectively retransmit uncompressed AV data according to the significance of the data when the data is transmitted or received. As a result, it is possible to improve the efficiency of retransmission and ensure the stability of retransmission.

What is claimed is:

1. A method of transmitting uncompressed audio and/or video (AV) data, the method comprising:
transmitting the uncompressed AV data;
determining whether an error occurs in the uncompressed AV data during the transmission; and
if it is determined that the error occurs in the uncompressed AV data, retransmitting a portion of the uncompressed AV data having a predetermined level of significance.

2. The method of claim 1, wherein the retransmitting of the portion of the uncompressed AV data is performed only if it is determined that the error occurs in data included in the portion of the uncompressed AV data.

3. The method of claim 1, further comprising:
setting a code rate for correcting the error to be lower than a code rate used for the transmitting the uncompressed AV data; and
performing error correction coding on the portion of the uncompressed AV data before the retransmitting.

4. The method of claim 3, wherein setting the code rate for the correcting the error is performed on the basis of a reduction ratio of an amount of the portion of the uncompressed AV data when the error correction coding is performed on the portion of the uncompressed AV data.

5. The method of claim 1, wherein the portion of the uncompressed AV data comprises a most significant bit of the uncompressed AV data.

6. The method of claim 1, further comprising:
separating the uncompressed AV data into a plurality of levels;
multiplexing the separated uncompressed AV data according to the levels; and
transmitting the multiplexed uncompressed AV data.

7. The method of claim 1, wherein the determining of the error occurrence is performed when an error response is received from a receiving apparatus that receives the transmitted uncompressed AV data.

8. A method of receiving uncompressed audio and/or video (AV) data, the method comprising:
receiving the uncompressed AV data;
determining whether an error occurs in the received uncompressed AV data; and
if it is determined that the error occurs in the received uncompressed AV data, requesting a transmitting apparatus which transmitted the uncompressed AV data to retransmit a portion of the uncompressed AV data having a predetermined level of significance.

9. The method of claim 8, wherein the requesting the transmitting apparatus to retransmit the portion of the uncompressed AV data is performed only if it is determined that the error occurs in data included in the portion of the uncompressed AV data.

10. The method of claim 8, further comprising:
receiving from the transmitting apparatus the portion of the uncompressed AV data in response to the requesting; and
combining the portion of the uncompressed AV data, received in response to the requesting, with remaining portion of the uncompressed AV data outside the predetermined level of significance to generate final reception data.

11. The method of claim 8, wherein the uncompressed AV data comprises multiplexed data classified into a plurality of levels.

12. The method of claim 8, wherein the portion of the uncompressed AV data comprises a most significant bit of the uncompressed AV data.

13. An apparatus for transmitting uncompressed AV data, the apparatus comprising:
a transmitting unit which transmits the uncompressed AV data; and
a retransmitting unit which, if an error occurs in the uncompressed AV data, retransmits a portion of the uncompressed AV data having a predetermined level of significance.

14. The apparatus of claim 13, wherein the retransmitting unit retransmits the portion of the uncompressed AV data only if it is determined that the error occurs in data included in the portion of the uncompressed AV data.

15. The apparatus of claim 13, further comprising a channel coding unit which performs error correction coding on the portion of the uncompressed AV data.

16. The apparatus of claim 15, wherein the channel coding unit sets a code rate for the error correction coding to be lower than a code rate used by the transmitting unit to transmit the uncompressed AV data.

17. The apparatus of claim 16, wherein the channel coding unit sets the code rate on the basis of a reduction ratiq of an amount of the portion of the uncompressed AV data when the error correction coding is performed.

18. The apparatus of claim 13 further comprising:
a bit separating unit which separates the uncompressed AV data into a plurality of levels; and
a multiplexer which multiplexes the separated uncompressed AV data according to the levels.

19. The apparatus of claim 13, wherein the portion of the uncompressed AV data comprises a most significant bit of the uncompressed AV data.

20. The apparatus of claim 13, wherein the occurrence of the error is determined when an error response is received from a receiving apparatus that receives the transmitted uncompressed AV data.

21. An apparatus for receiving uncompressed AV data, the apparatus comprising:
a receiving unit which receives the uncompressed AV data;
a determining unit which determines whether an error occurs in the received uncompressed AV data; and
an error response generating unit which requests a transmitting apparatus which transmitted the uncompressed AV data to retransmit a portion of the uncompressed AV data having a predetermined level of significance if it is determined that the error occurs in the uncompressed AV data.

22. The apparatus of claim 21, wherein the error response generating unit requests the transmitting apparatus to retransmit the portion of the uncompressed AV data only if it is determined that the error occurs in data included in the portion of the uncompressed AV data.

23. The apparatus of claim 21, wherein the determining unit comprises a channel decoding unit which performs error correction decoding on the uncompressed AV data, determines the error occurrence, and controls the error response generating unit to request the transmitting apparatus to retransmit the portion of the uncompressed AV data.

24. The apparatus of claim 21, further comprising a demultiplexer which combines the portion of the uncompressed AV data, retransmitted by the transmitting apparatus in response to the request of the error response generating unit, with remaining portion of the uncompressed AV data outside the predetermined level of significance to generate final reception data.

25. The apparatus of claim 21, wherein the uncompressed AV data comprises multiplexed data classified into a plurality of bit levels.

26. The apparatus of claim 21, wherein the portion of the uncompressed AV data comprises a most significant bit of the uncompressed AV data.
